(19) United States
(12) Patent Application Publication
(10) Pub. No.: US 2025/0237548 A1
(43) Pub. Date: Jul. 24, 2025

(54) INSTRUMENTAL ERROR TRACKING AND IDENTIFICATION METHOD, INSTRUMENTAL ERROR TRACKING AND IDENTIFICATION SYSTEM AND OPTICAL METROLOGY TOOL

(71) Applicant: Taiwan Semiconductor Manufacturing Company, Ltd., Hsinchu (TW)

(72) Inventors: JAN HAU CHANG, Hsinchu (TW); Hsien-Hung CHANG, Hsinchu (TW); Yun-Chung TENG, Hsinchu (TW); Min-Hsiung FU, Hsinchu (TW)

(73) Assignee: Taiwan Semiconductor Manufacturing Company, Ltd., Hsinchu (TW)

(21) Appl. No.: 18/421,546

(22) Filed: Jan. 24, 2024

(51) Int. Cl. G01J 3/02; G01J 3/42; G01N 21/21; G01N 21/25; G01N 21/95

(52) U.S. Cl. CPC G01J 3/027; G01N 21/255; G01N 21/9501; G01J 2003/425; G01N 2021/213

(57) ABSTRACT

An instrumental error tracking and identification method, an instrumental error tracking and identification system and an optical metrology tool are provided. The instrumental error tracking and identification method is for an optical metrology tool in semiconductor fabrication facility. The instrumental error tracking and identification method includes: collecting a plurality of measured spectrums including a spectroscopic ellipsometry (SE) Mueller spectrum matrix or two spectroscopic reflectometry (SR) spectrums from a standard wafer measured by the optical metrology tool; evaluating a performance index of the optical metrology tool, wherein the performance index is a fitting residue for a single wavelength or an area under curve (AUC) for a wavelength interval; and continuously tracking and identifying an instrumental error according to the performance index.

### BACKGROUND

The disclosure relates in general to an error tracking and identification method, an error tracking and identification system and a metrology tool, and more particularly to an instrumental error tracking and identification method, an instrumental error tracking and identification system and an optical metrology tool.

In most cases, the internal calibration control unit is used to calibrate the commercial spectrometer. However, existing procedure may be time consuming and may not to prove the correctness of calibration mechanism as they generally lack of universal criteria for tool maintenance, which are crucial to optical measurement.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 shows an optical metrology tool according to one embodiment.

FIG. 2 shows a flowchart of an instrumental error tracking and identification method according to one embodiment.

FIG. 3 shows a spectroscopic ellipsometry (SE) mode of the optical metrology tool according to one embodiment.

FIG. 4 shows a spectroscopic reflectometry (SR) mode of the optical metrology tool according to one embodiment.

FIG. 5 shows an example of an instrumental error pattern according to one embodiment.

FIG. 6 illustrates evaluating a fitting residue for a single wavelength according to one embodiment.

FIGS. 7A to 7B illustrate evaluating an area under curve for a wavelength interval according to one embodiment.

FIG. 8 illustrates evaluating the fitting residue for symmetrical channels according to one embodiment.

FIG. 9 illustrates the settings for different channels according to one embodiment.

FIG. 10 illustrates the spectroscopic ellipsometry Mueller spectrum matrix according to one embodiment.

FIG. 11 illustrates the shapes of the spectroscopic ellipsometry Mueller spectrum matrix according to one embodiment.

FIG. 12 illustrates the expressions of the theoretical spectrums in the spectroscopic ellipsometry Mueller spectrum matrix according to one embodiment.

FIG. 13 illustrates some of the matrix elements whose theoretical value is 0 in the spectroscopic ellipsometry Mueller spectrum matrix according to one embodiment.

FIG. 14 illustrates the matrix element whose theoretical value is 1 or any constant value in the spectroscopic ellipsometry Mueller spectrum matrix according to one embodiment.

FIG. 15 illustrates some of the matrix elements which are symmetry theoretically in the spectroscopic ellipsometry Mueller spectrum matrix according to one embodiment.

FIG. 16 illustrates the spectroscopic reflectometry (SR) spectrums according to one embodiment.

FIG. 17 illustrate the instrumental error classification.

FIG. 18 illustrate an example for monitoring the stage tilt according to one embodiment.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

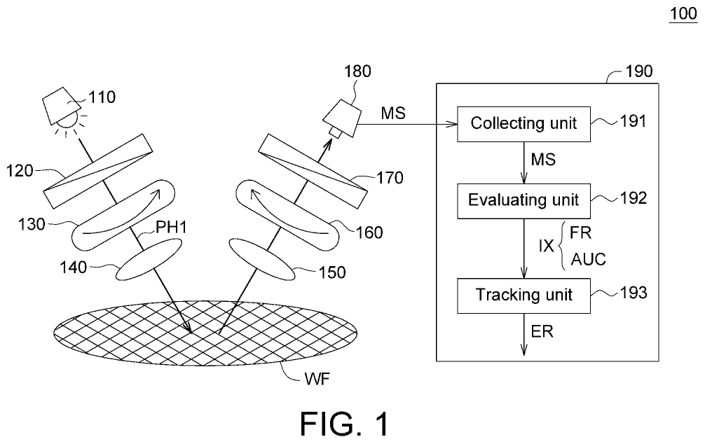

FIG. 1 shows an optical metrology tool 100 according to one embodiment. The optical metrology tool 100 is any tool that uses spectra to measure. The optical metrology tool 100 includes a light source 110, a polarizer 120, an incoming light compensator 130, a focus lens 140, a collecting lens 150, a transmit light compensator 160, an analyzer 170, a detector 180 and an instrumental error tracking and identification system 190. The light source 110, the polarizer 120, the incoming light compensator 130, the focus lens 140, the collecting lens 150, the transmit light compensator 160, the analyzer 170 and the detector 180 are arranged in sequence on a light path PH1. The instrumental error tracking and identification system 190 is a circuit, a circuit board, a chip or a storage device storing program codes. The instrumental error tracking and identification system 190 includes a collecting unit 191, an evaluating unit 192 and a tracking unit 193. The collecting unit 191 is used for collecting measured spectrums MS. The evaluating unit 192 is used for evaluating a performance index IX according to the measured spectrums MS. The tracking unit 193 is used for tracking and identifying an instrumental error ER according to the performance index IX.

In the present disclosure, the instrumental error tracking and identification system 190 is a real-time monitoring system provides quantitative methods for instrumental error identification. The instrumental error tracking and identification system 190 can provide continuous and sensitive monitoring of the instrumental errors ER without pausing the optical metrology tool 100 or adding sensors. This technology can be applied on spectral fitting semiconductor metrology tool, such as Optical Critical Dimension (OCD).

The instrumental error tracking and identification system 190 provides hardware insights for tool maintenance based on the real-time collected performance index IX.

By the technology disclosed in this disclosure, real-time inline monitoring of the instrumental errors ER can rapidly identify the issues of the optical metrology tool 100 and greatly reduce the impacts on semiconductor products. Compared to state-of-the-art methods, this technology provide higher sampling rate and sensitivity, helping high-volume manufacturing (HVM) fabs maintain optical metrology tools 100 at higher level of stability and accuracy.

The instrumental error tracking and identification system 190 provides index directly indicating deficiencies and aging (associated with) of specific optical elements in the optical metrology tool 100, such as the light source 110, the polarizer 120, the incoming light compensator 130, the transmit light compensator 160 and the analyzer 170, and the stage.

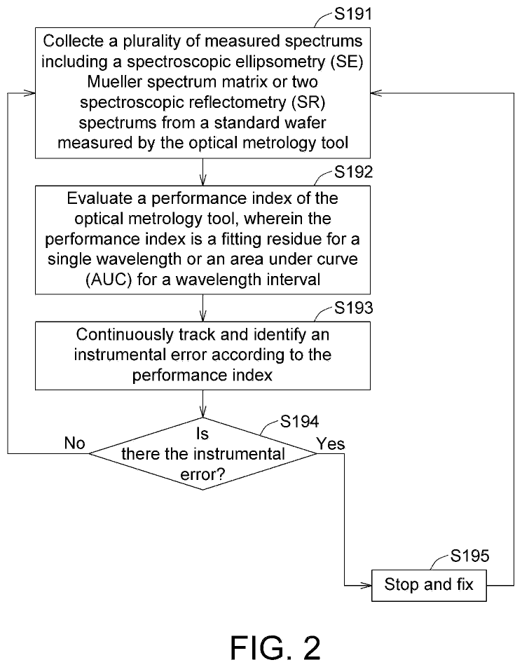

Please refer to FIG. 2, which shows a flowchart of an instrumental error tracking and identification method according to one embodiment. The instrumental error tracking and identification method includes steps S191 to S195. In the step S191, as shown in FIG. 1, the collecting unit 191 collects a plurality of measured spectrums MS from a standard wafer WF measured by the optical metrology tool 100. The standard wafer WF is, for example, a bare-Si wafer, an isotropic wafer, or a blank wafer.

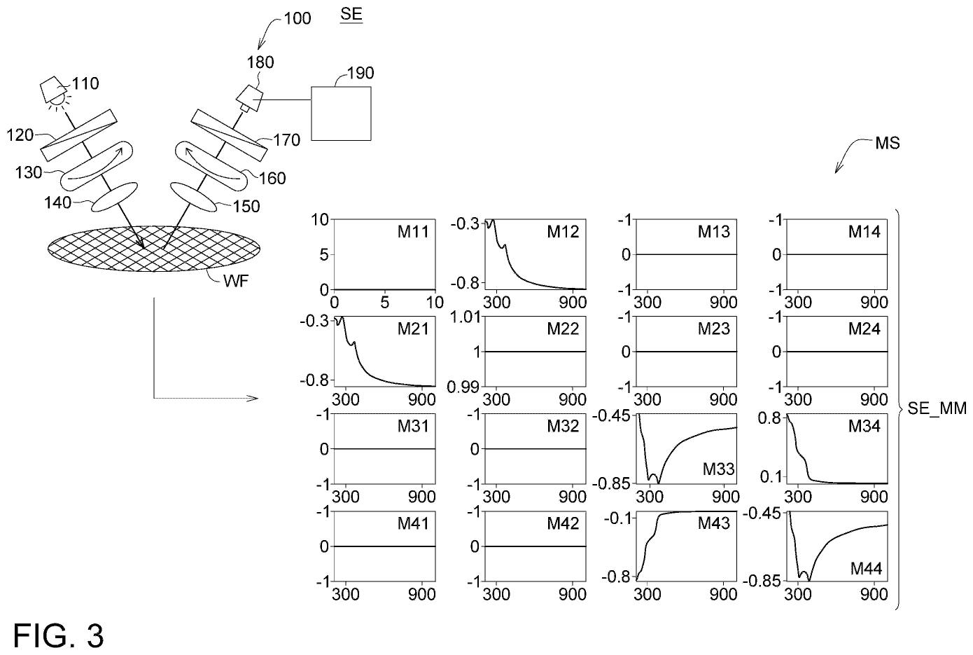

Please refer to FIG. 3, which shows a spectroscopic ellipsometry mode SE of the optical metrology tool 100 according to one embodiment. In the spectroscopic ellipsometry mode SE, the collecting unit 191 collects the measured spectrums MS including a spectroscopic ellipsometry Mueller spectrum matrix SE_MM. The spectroscopic ellipsometry Mueller spectrum matrix SE_MM includes matrix elements M11 to M44 which are measured through different settings of the optical metrology tool 100.

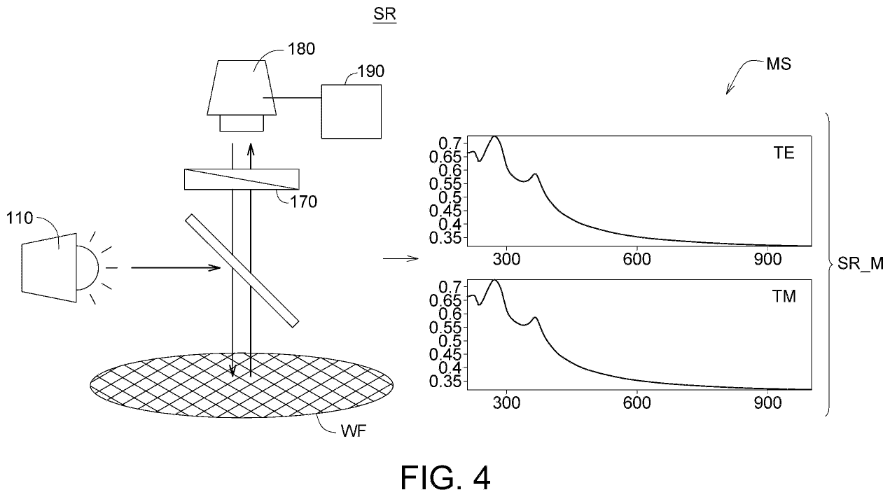

Please refer to FIG. 4, which shows a spectroscopic reflectometry mode SR of the optical metrology tool 100 according to one embodiment. In the spectroscopic reflectometry mode SR, the collecting unit 191 collects the measured spectrums MS including a transverse electric spectrum TE and a transverse magnetic spectrum TM which are identical theoretically.

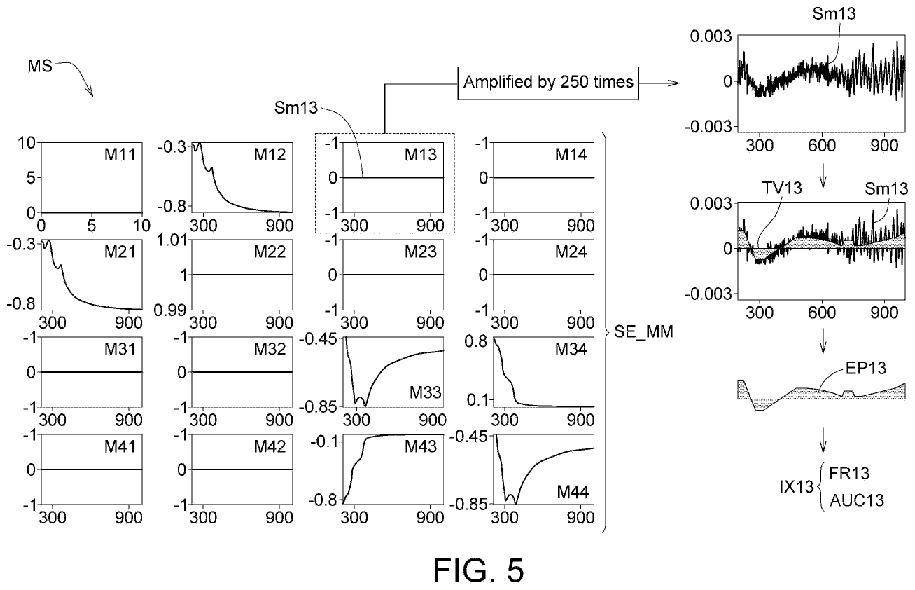

Next, in the step S192, as shown in FIG. 1, the evaluating unit 192 evaluates a performance index IX of the optical metrology tool 100. Please refer to FIG. 5, which shows an example of an instrumental error pattern EP13 according to one embodiment. Taken the matrix element M13 as an example, an instrumental error signal Sm13 is amplified, for example, by 250 times. Then, the instrumental error signal Sm13 is compared with a theoretical value TV13 to obtain the instrumental error pattern EP13. The theoretical value TV13 of the matrix element M13 is 0. Next, a performance index IX13 including a fitting residue FR13 for a single wavelength or an area under curve (AUC) AUC13 for a wavelength interval is obtained.

For isotropic depolarizing wafer, for example, the bare-Si wafer, an isotropic wafer, or a blank wafer, the matrix element M13 remain 0 in the case of fully depolarized light. If the matrix element M13 shows the fitting residue RF and/or area under curve AUC between actual and theoretical spectrum, it is a clear sign that the source-side polarizer is deficient. Also, the fitting residue RF and/or area under curve AUC can be calculated as the performance index IX which is used to track the stability and accuracy of spectrometer. For example, the performance index IX could be monitored in a history chart.

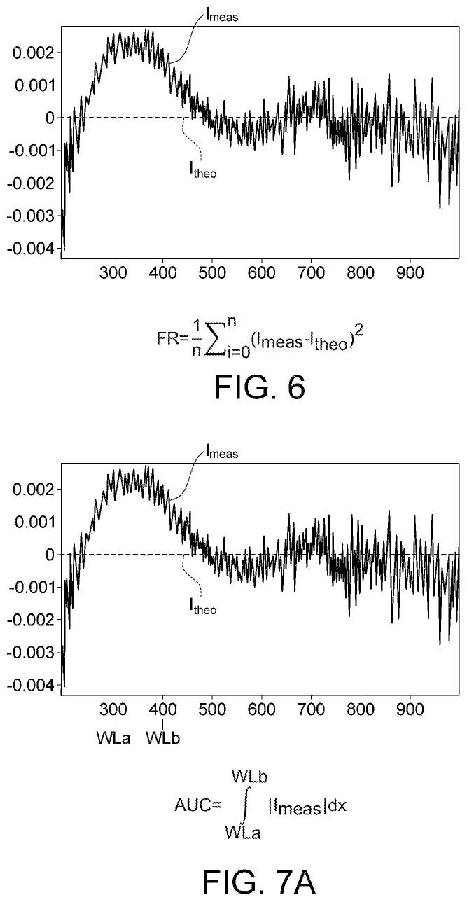

Please refer to FIG. 6, which illustrates evaluating the fitting residue FR for a single wavelength according to one embodiment. The fitting residue FR for a single wavelength is evaluated according to an average sum of squared differences between measured intensities Imeas and theoretical intensities Itheo. For example, the fitting residue FR for a single wavelength is evaluated according to the following equation (1).

$$FR = \frac{1}{n} {\sum }_{i = 0}^{n} {( {I}_{m e a s} - {I}_{theo} )}^{2} \qquad ( 1 )$$

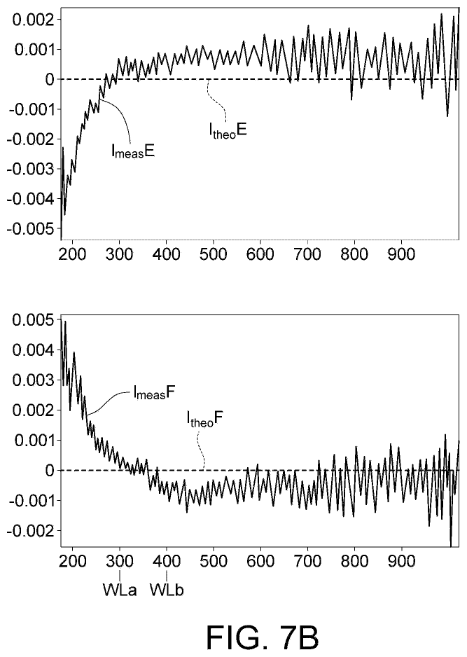

Please refer to FIGS. 7A to 7B, which illustrates evaluating the area under curve AUC for a wavelength interval according to one embodiment. The area under curve AUC for a wavelength interval is evaluated according to an integral operation on measured intensities Imeas. For example, as shown in the FIG. 7A, the area under curve AUC for a wavelength interval is evaluated according to the following equation (2). Or, as shown in the FIG. 7B, the area under curve AUC for a wavelength interval is evaluated according to the following equation (3). In the FIG. 7B, the spectrums with the theoretical intensities ItheoE, ItheoF are symmetry theoretically.

$$AUC = {\int }_{W L a}^{WLb} \vert {I}_{m e a s} \vert dx \qquad ( 2 )$$

$$AUC = {\int }_{W L a}^{WLb} ( \vert {I}_{m e a s E} \vert - \vert {I}_{measF} \vert ) dx \qquad ( 3 )$$

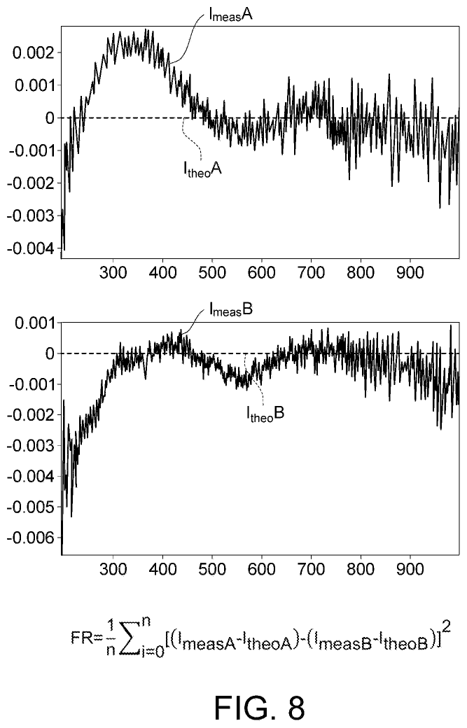

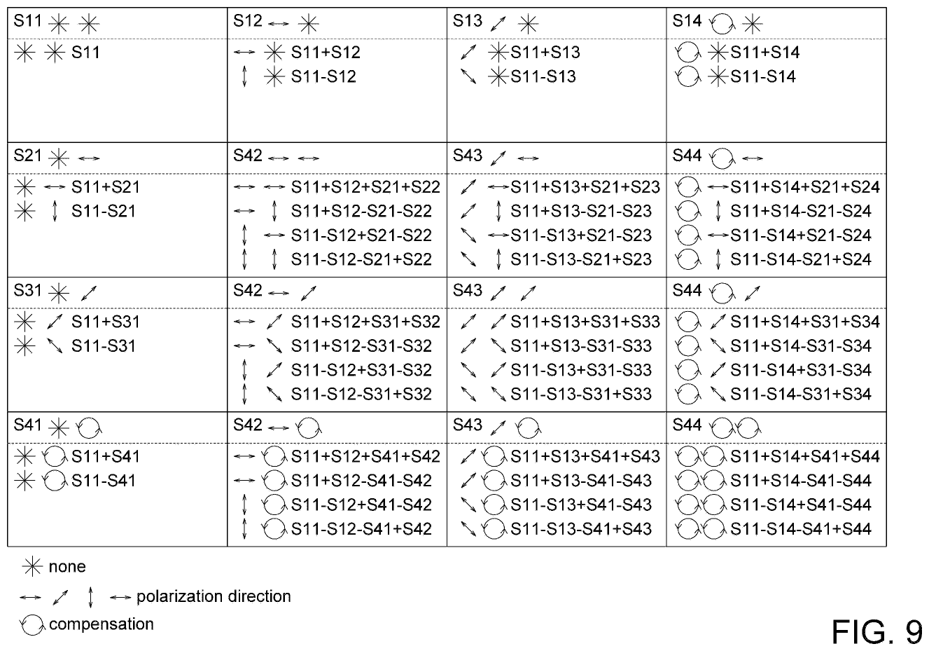

Please refer to FIG. 8, which illustrates evaluating the fitting residue FR for symmetrical channels according to one embodiment. For example, the fitting residue FR for symmetrical channels is evaluated according to the following equation (4).

$$FR = \frac{1}{n} {{\sum }_{i = 0}^{n} [ ( {I}_{m e a s A} - {I}_{theoA} ) - ( {I}_{m e a s B} - {I}_{theoB} ) ]}^{2} \qquad ( 4 )$$

Then, in the step S193, as shown in FIG. 1, the tracking unit 193 continuously tracks and identifies the instrumental error ER according to the performance index IX.

Next, in the step S194, the tracking unit 193 determines whether there is the instrumental error ER according to the performance index IX. If there is the instrumental error ER, the process proceeds to the step S195.

In the step S195, the optical metrology tool 100 is stopped and then fixed.

The instrumental error tracking and identification system 190 and the instrumental error tracking and identification method described above is and actual/theoretical spectrum residual analysis system and method. The mathematical models, such as RCWA, is used to calculate the performance index IX for the optical metrology too (for example, the OCD tools). This performance index IX is associated with instrumental error ER and optical element deficiency. By applying the performance index IX on measurement of specific control wafer types and creating a continuous monitoring flow, the system can provide real-time status of individual optical metrology tools.

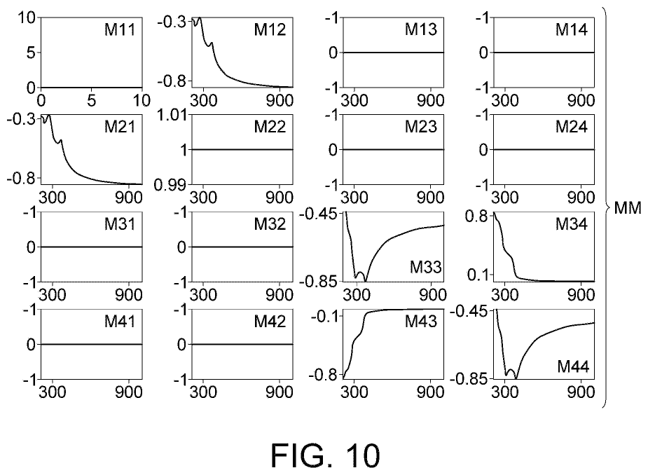

Please refer to FIG. 9 and FIG. 10. FIG. 9 illustrates the settings for different channels according to one embodiment. FIG. 10 illustrates the spectroscopic ellipsometry Mueller spectrum matrix SE_MM according to one embodiment. Reference of the FIG. 9 is “Am. J. Phys. 53, 468-478 (1985) William S. Bickel; Wilbur M. Bailey, Stokes vectors, Mueller matrices, and polarized scattered light”. As shown in the FIG. 9, the symbol on the left represents the setting for the incoming light, and the symbol on the right represents the setting for the transmit light. The setting includes the polarization direction and the compensation. The settings S11 to S44 shown in the FIG. 9 are used for the matrix elements M11 to M44 in the spectroscopic ellipsometry Mueller spectrum matrix SE_MM shown in the FIG. 10.

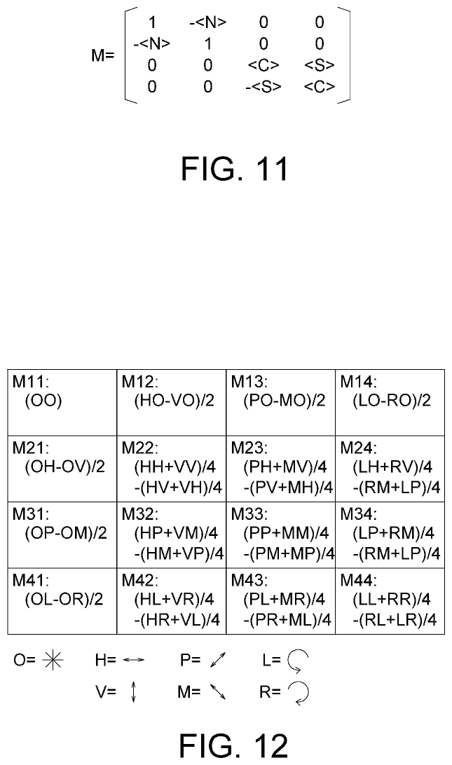

Please refer to FIG. 11, which illustrates the shapes of the spectroscopic ellipsometry Mueller spectrum matrix SE_MM according to one embodiment. For an isotropic sample, but potentially depolarizing sample, the spectroscopic ellipsometry Mueller spectrum matrix SE_MM would have the shape shown in the FIG. 11. N, C, and S are related to the ellipsometry parameters from. N=cos(2Ψ), C=sin(2Ψ) cos(Δ), S=sin(2Ψ)sin(Δ). Ψ is related to the amplitude ratio and Δ is related to a phase difference between p- and s-polarized light resulting from interaction with the sample.

Please refer to FIG. 12, which illustrates the expressions of the theoretical spectrums in the spectroscopic ellipsometry Mueller spectrum matrix SE_MM according to one embodiment. Reference of the FIG. 12 is “22 Dec. 1997/Vol. 1, No. 13/OPTICS EXPRESS 441 Diffuse backscattering Mueller matrices of highly scattering media, Andreas H. Hielscher, Angelia A. Eick, Judith R. Mourant, Dan Shen*, James P. Freyer*, and Irving J. Bigio”. According to those expressions, the theoretical spectrums of the matrix elements in the spectroscopic ellipsometry Mueller spectrum matrix SE_MM could be obtained. For example, “HV” means that the polarizer 120 for the incoming light is linearly polarized along the horizontal axis and the analyzer 170 for the transmit light is linearly polarized along the vertical axis.

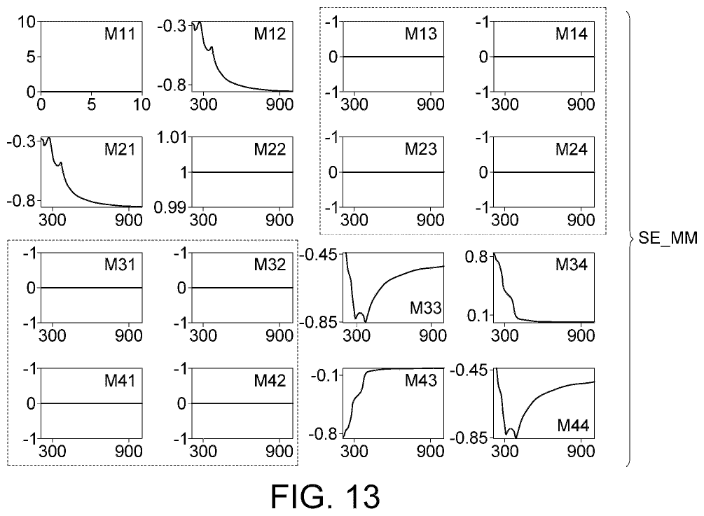

Please refer to FIG. 13, which illustrates some of the matrix elements whose theoretical value is 0 in the spectroscopic ellipsometry Mueller spectrum matrix SE_MM according to one embodiment. If the standard wafer is a bare-Si wafer, an isotropic wafer, or a blank wafer, the theoretical value of the matrix elements M13, M14, M23, M24, M31, M32, M41, M42 is 0.

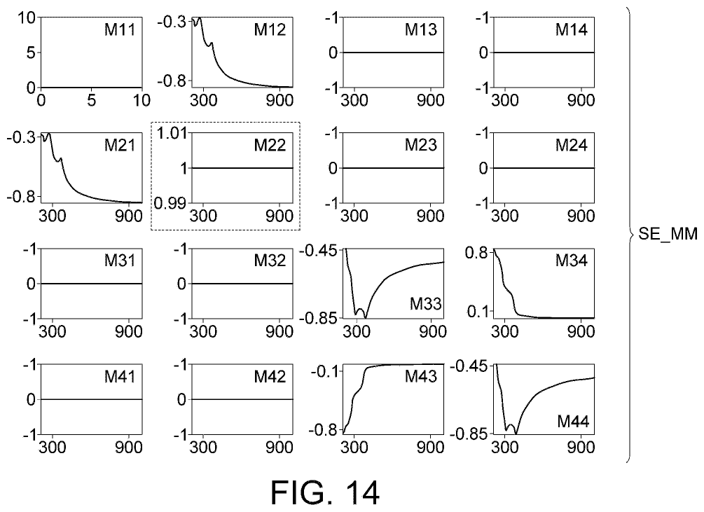

Please refer to FIG. 14 illustrates the matrix element whose theoretical value is 1 in the spectroscopic ellipsometry Mueller spectrum matrix SE_MM according to one embodiment. If the standard wafer is a bare-Si wafer, an isotropic wafer, or a blank wafer, the theoretical value of the matrix elements M22 is 1 or any constant value.

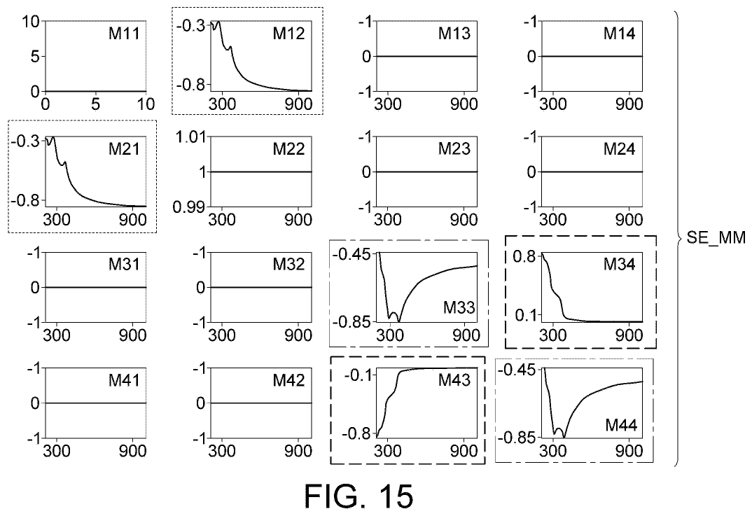

Please refer to FIG. 15 illustrates some of the matrix elements which are symmetry theoretically in the spectroscopic ellipsometry Mueller spectrum matrix SE_MM according to one embodiment. If the standard wafer is a bare-Si wafer, an isotropic wafer, or a blank wafer, the theoretical spectrums of the matrix elements M12 and M21 are symmetry theoretically, the theoretical spectrums of the matrix elements M33 and M44 are symmetry theoretically, and the theoretical spectrums of the matrix elements M34 and M43 are symmetry theoretically. “Symmetry theoretically” means that the revise theoretical spectrum of one matrix element and the theoretical spectrum of another matrix element are identical theoretically. The fitting residue FR for those symmetrical channels could be evaluated through the steps described in the FIG. 8.

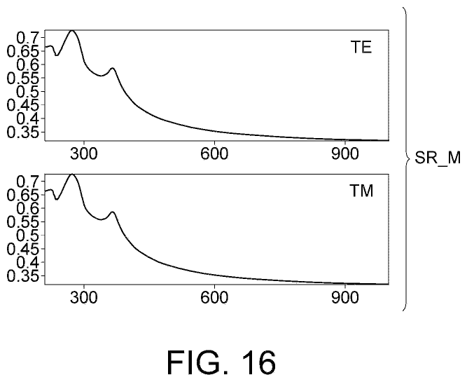

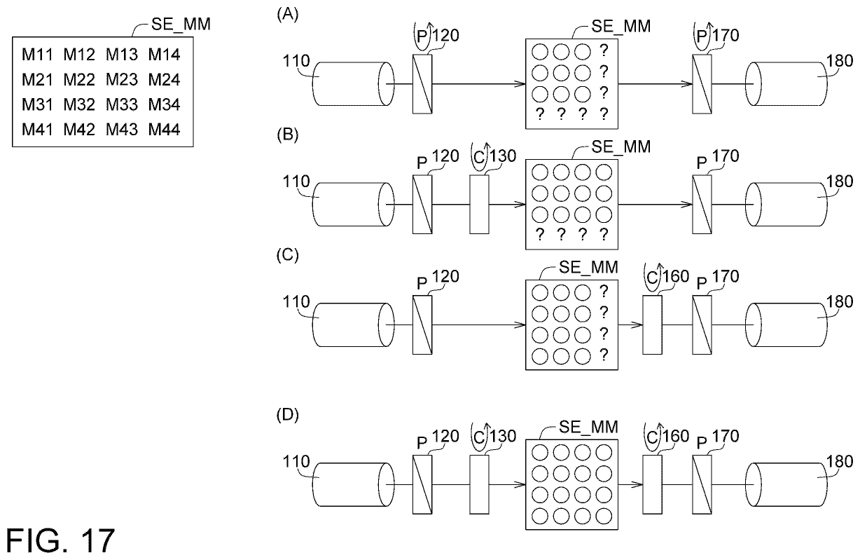

Please refer to FIG. 16 illustrates the spectroscopic reflectometry (SR) spectrums SR_M according to one embodiment. The SR spectrums SR_M include a transverse electric spectrum TE and a transverse magnetic spectrum TM which are identical theoretically. The fitting residue FR for those symmetrical channels could be evaluated through the steps described in the FIG. 8.

Please refer to FIG. 17, which illustrate the instrumental error classification. The performance index IX of the matrix elements M11 to M44 could be tracked according to one embodiment. Reference of the FIG. 17 is “Published by De Gruyter Jun. 7, 2022, Mueller matrix spectroscopic ellipsometry, James N. Hilfiker ORCID, Nina Hong and Stefan Schoeche, From the journal Advanced Optical Technologies (https://doi.org/10.1515/aot-2022-0008)”. As shown in the drawing (Δ) in the FIG. 17, if the performance index IX of any of the matrix elements M11, M12, M13, M21, M22, M23, M31, M32, M33 is abnormal, an instrumental error ER might be happened at the light source 110, the polarizer 120 or the analyzer 170. As shown in the drawing (B) in the FIG. 17, if the performance index IX of any of the matrix elements M11, M12, M13, M14, M21, M22, M23, M24, M31, M32, M33, M34 is abnormal, an instrumental error ER might be happened at the light source 110, the polarizer 120, the incoming light compensator 130 or the analyzer 170. As shown in the drawing (C) in the FIG. 17, if the performance index IX of any of the matrix elements M11, M12, M13, M21, M22, M23, M31, M32, M33, M41, M42, M43 is abnormal, an instrumental error ER might be happened at the light source 110, the polarizer 120, the transmit light compensator 160, or the analyzer 170. As shown in the drawing (D) in the FIG. 17, if the performance index IX of any of the matrix elements M11, M12, M13, M14, M21, M22, M23, M24, M31, M32, M33, M34, M41, M42, M43, M44 is abnormal, an instrumental error ER might be happened at the light source 110, the polarizer 120, the incoming light compensator 13, the transmit light compensator 160, or the analyzer 170.

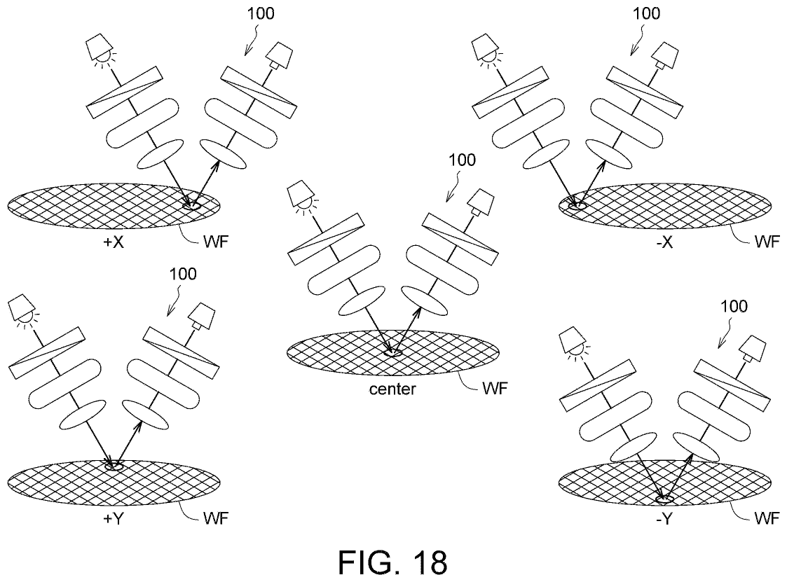

Please refer to FIG. 18, which illustrate an example for monitoring the stage tilt according to one embodiment. The optical metrology tool 100 may be used to measure five points located at the center and four extreme point of the standard wafer WF. In theory, the performance indexes IX obtained through measuring at the five points should be identical. The stage tilt could be monitored based on whether the performance indexes IX obtained through measuring at the five points are identical.

According to the embodiments described above, a zero-point calibration systems and methods for spectrometer (e.g., Spectroscopic Ellipsometry/Spectroscopic Reflectometry) are built using optical formula and calculation on residual analysis. This brand-new calibration mechanism is very first configured to track and identify instrumental error in the metrology field of semiconductor industry.

This technology allows for system to track and identify instrumental error without switching equipment to off-line mode. It could realize the real-time fault diagnosis with low operating costs and low production capacity impact.

In the presented technology, the ultra-high-sensitivity instrumental error inspection could be enabled. The inspection mechanism provides greater spectrum-bias resolving power than any system/method in traditional.

This system provides universal criteria based on optical formula for tool maintenance, that is crucial for instrumental error detection in semiconductor fabrication facility, especially for High Volume Manufacturing.

Moreover, the present system and method utilizes optical formulas and calculations for residual analysis, which play a significant part in identifying and classifying instrumental errors. This unique feature is helpful to minimize the performance mismatching and improve the stability/accuracy of spectrometer.

In this disclosure, at least the following example embodiments are disclosed.

According to one example embodiment, an instrumental error tracking and identification method for an optical metrology tool in semiconductor fabrication facility is provided. The instrumental error tracking and identification method includes: collecting a plurality of measured spectrums including a spectroscopic ellipsometry (SE) Mueller spectrum matrix or two spectroscopic reflectometry (SR) spectrums from a standard wafer measured by the optical metrology tool; evaluating a performance index of the optical metrology tool, wherein the performance index is a fitting residue for a single wavelength or an area under curve (AUC) for a wavelength interval; and continuously tracking and identifying an instrumental error according to the performance index.

Based on the instrumental error tracking and identification method described in the previous embodiments, the standard wafer is a bare-Si wafer, an isotropic wafer, or a blank wafer.

Based on the instrumental error tracking and identification method described in the previous embodiments, the SE Mueller spectrum matrix includes a spectrum whose theoretical value is 0.

Based on the instrumental error tracking and identification method described in the previous embodiments, the SE Mueller spectrum matrix includes a spectrum whose theoretical value is 1 or a constant value.

Based on the instrumental error tracking and identification method described in the previous embodiments, the SE Mueller spectrum matrix includes two spectrums which are symmetry theoretically or identical theoretically.

Based on the instrumental error tracking and identification method described in the previous embodiments, the SR spectrums include a transverse electric (TE) spectrum and a transverse magnetic (TM) spectrum which are identical theoretically.

Based on the instrumental error tracking and identification method described in the previous embodiments, the fitting residue is evaluated according to an average sum of squared differences between measured intensities and theoretical intensities.

Based on the instrumental error tracking and identification method described in the previous embodiments, the area under curve (AUC) is evaluated according to an integral operation on measured intensities.

Based on the instrumental error tracking and identification method described in the previous embodiments, the optical metrology tool includes a light source, a polarizer, an incoming light compensator, a focus lens, a collecting lens, a transmit light compensator, an analyzer and a detector which are arranged in sequence on a light path, the instrumental error is identified on the light source, the polarizer, the incoming light compensator, the focus lens, the collecting lens, the transmit light compensator or the analyzer.

According to one example embodiment, an instrumental error tracking and identification system for an optical metrology tool in semiconductor fabrication facility is provided. The instrumental error tracking and identification system includes a collecting unit, an evaluating unit and a tracking unit. The collecting unit is configured for collecting a plurality of measured spectrums including a spectroscopic ellipsometry (SE) Mueller spectrum matrix or two spectroscopic reflectometry (SR) spectrums from a standard wafer measured by the optical metrology tool. The evaluating unit is configured for evaluating a performance index of the optical metrology tool. The performance index is a fitting residue for a single wavelength or an area under curve (AUC) for a wavelength interval. The tracking unit is configured for continuously tracking and identifying an instrumental error according to the performance index.

Based on the instrumental error tracking and identification system described in the previous embodiments, the standard wafer is a bare-Si wafer, an isotropic wafer, or a blank wafer.

Based on the instrumental error tracking and identification system described in the previous embodiments, the SE Mueller spectrum matrix includes a spectrum whose theoretical value is 0.

Based on the instrumental error tracking and identification system described in the previous embodiments, the SE Mueller spectrum matrix includes a spectrum whose theoretical value is 1 or a constant value.

Based on the instrumental error tracking and identification system described in the previous embodiments, the SE Mueller spectrum matrix includes two spectrums which are symmetry theoretically or identical theoretically.

Based on the instrumental error tracking and identification system described in the previous embodiments, the SR spectrums include a transverse electric (TE) spectrum and a transverse magnetic (TM) spectrum which are identical theoretically.

Based on the instrumental error tracking and identification system described in the previous embodiments, the fitting residue is evaluated according to an average sum of squared differences between measured intensities and theoretical intensities.

Based on the instrumental error tracking and identification system described in the previous embodiments, the area under curve (AUC) is evaluated according to an integral operation on measured intensities.

Based on the instrumental error tracking and identification system described in the previous embodiments, the optical metrology tool includes a light source, a polarizer, an incoming light compensator, a focus lens, a collecting lens, a transmit light compensator, an analyzer and a detector which are arranged in sequence on a light path, the instrumental error is identified on the light source, the polarizer, the incoming light compensator, the focus lens, the collecting lens, the transmit light compensator or the analyzer.

According to one example embodiment, an optical metrology tool is provided. The optical metrology tool includes a light source, a polarizer, an incoming light compensator, a focus lens, a collecting lens, a transmit light compensator, an analyzer, a detector and an instrumental error tracking and identification system. The light source, the polarizer, the incoming light compensator, the focus lens, the collecting lens, the transmit light compensator, the analyzer and the detector are arranged in sequence on a light path. The instrumental error tracking and identification system includes a collecting unit, an evaluating unit and a tracking unit. The collecting unit is configured for collecting a plurality of measured spectrums including a spectroscopic ellipsometry (SE) Mueller spectrum matrix or two spectroscopic reflectometry (SR) spectrums from a standard wafer measured by the optical metrology tool. The evaluating unit is configured for evaluating a performance index of the optical metrology tool. The performance index is a fitting residue for a single wavelength or an area under curve (AUC) for a wavelength interval. The tracking unit is configured for continuously tracking and identifying an instrumental error according to the performance index.

Based on the optical metrology tool described in the previous embodiments, the instrumental error is identified on the light source, the polarizer, the incoming light compensator, the focus lens, the collecting lens, the transmit light compensator or the analyzer.

It is noted that the terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An instrumental error tracking and identification method for an optical metrology tool in semiconductor fabrication facility, comprising:
collecting a plurality of measured spectrums including a spectroscopic ellipsometry (SE) Mueller spectrum matrix or two spectroscopic reflectometry (SR) spectrums from a standard wafer measured by the optical metrology tool;
evaluating a performance index of the optical metrology tool, wherein the performance index is a fitting residue for a single wavelength or an area under curve (AUC) for a wavelength interval; and
continuously tracking and identifying an instrumental error according to the performance index.

2. The instrumental error tracking and identification method according to claim 1, wherein the standard wafer is a bare-Si wafer, an isotropic wafer, or a blank wafer.

3. The instrumental error tracking and identification method according to claim 1, wherein the SE Mueller spectrum matrix includes a spectrum whose theoretical value is 0.

4. The instrumental error tracking and identification method according to claim 1, wherein the SE Mueller spectrum matrix includes a spectrum whose theoretical value is 1 or a constant value.

5. The instrumental error tracking and identification method according to claim 1, wherein the SE Mueller spectrum matrix includes two spectrums which are symmetry theoretically or identical theoretically.

6. The instrumental error tracking and identification method according to claim 1, wherein the SR spectrums include a transverse electric (TE) spectrum and a transverse magnetic (TM) spectrum which are identical theoretically.

7. The instrumental error tracking and identification method according to claim 1, wherein the fitting residue is evaluated according to an average sum of squared differences between measured intensities and theoretical intensities.

8. The instrumental error tracking and identification method according to claim 1, wherein the area under curve (AUC) is evaluated according to an integral operation on measured intensities.

9. The instrumental error tracking and identification method according to claim 1, wherein the optical metrology tool includes a light source, a polarizer, an incoming light compensator, a focus lens, a collecting lens, a transmit light compensator, an analyzer and a detector which are arranged in sequence on a light path, the instrumental error is identified on the light source, the polarizer, the incoming light compensator, the focus lens, the collecting lens, the transmit light compensator or the analyzer.

10. An instrumental error tracking and identification system for an optical metrology tool in semiconductor fabrication facility, comprising:
a collecting unit, configured for collecting a plurality of measured spectrums including a spectroscopic ellipsometry (SE) Mueller spectrum matrix or two spectroscopic reflectometry (SR) spectrums from a standard wafer measured by the optical metrology tool;
an evaluating unit, configured for evaluating a performance index of the optical metrology tool, wherein the performance index is a fitting residue for a single wavelength or an area under curve (AUC) for a wavelength interval; and
a tracking unit, configured for continuously tracking and identifying an instrumental error according to the performance index.

11. The instrumental error tracking and identification system according to claim 10, wherein the standard wafer is a bare-Si wafer, an isotropic wafer, or a blank wafer.

12. The instrumental error tracking and identification system according to claim 10, wherein the SE Mueller spectrum matrix includes a spectrum whose theoretical value is 0.

13. The instrumental error tracking and identification system according to claim 10, wherein the SE Mueller spectrum matrix includes a spectrum whose theoretical value is 1 or a constant value.

14. The instrumental error tracking and identification system according to claim 10, wherein the SE Mueller spectrum matrix includes two spectrums which are symmetry theoretically or identical theoretically.

15. The instrumental error tracking and identification system according to claim 10, wherein the SR spectrums include a transverse electric (TE) spectrum and a transverse magnetic (TM) spectrum which are identical theoretically.

16. The instrumental error tracking and identification system according to claim 10, wherein the fitting residue is evaluated according to an average sum of squared differences between measured intensities and theoretical intensities.

17. The instrumental error tracking and identification system according to claim 10, wherein the area under curve (AUC) is evaluated according to an integral operation on measured intensities.

18. The instrumental error tracking and identification system according to claim 10, wherein the optical metrology tool includes a light source, a polarizer, an incoming light compensator, a focus lens, a collecting lens, a transmit light compensator, an analyzer and a detector which are arranged in sequence on a light path, the instrumental error is identified on the light source, the polarizer, the incoming light compensator, the focus lens, the collecting lens, the transmit light compensator or the analyzer.

19. An optical metrology tool, comprising:
a light source;
a polarizer;
an incoming light compensator;
a focus lens;
a collecting lens;
a transmit light compensator;
an analyzer;
a detector, wherein the light source, the polarizer, the incoming light compensator, the focus lens, the collecting lens, the transmit light compensator, the analyzer and the detector are arranged in sequence on a light path; and
an instrumental error tracking and identification system, comprising:
a collecting unit, configured for collecting a plurality of measured spectrums including a spectroscopic ellipsometry (SE) Mueller spectrum matrix or two spectroscopic reflectometry (SR) spectrums from a standard wafer measured by the optical metrology tool;
an evaluating unit, configured for evaluating a performance index of the optical metrology tool, wherein the performance index is a fitting residue for a single wavelength or an area under curve (AUC) for a wavelength interval; and
a tracking unit, configured for continuously tracking and identifying an instrumental error according to the performance index.

20. The optical metrology tool according to claim 19, wherein the instrumental error is identified on the light source, the polarizer, the incoming light compensator, the focus lens, the collecting lens, the transmit light compensator or the analyzer.
